(19) United States
(12) Patent Application Publication
(10) Pub. No.: US 2008/0044718 A1
(43) Pub. Date: Feb. 21, 2008

(54) Column Type Fuel Cell, Series Device Thereof and Stack Thereof

(75) Inventors: Chung-Ping Wang, Hsinchu (TW); Chien-Chung Chang, Hsinchu (TW); Ju-Pei Chen, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Optodisc Technology Corporation, Hsinchu (TW)

(21) Appl. No.: 11/556,643

(22) Filed: Nov. 3, 2006

(30) Foreign Application Priority Data
Aug. 17, 2006 (TW) 95130206

(51) Int. Cl. H01M 8/02; H01M 8/24

(52) U.S. Cl. 429/38; 429/35

(57) ABSTRACT

A column type fuel cell is provided, including a column electrode, a first catalytic layer, one or more channels, an electrolyte layer, a second catalytic layer, and a ring electrode. The surrounding surface of the column electrode has several protruding blocks. The first catalytic layer is on the surrounding surface of the column electrode to form a pillar, and is connected to the protruding blocks to form the channel passing through two ends of the pillar. The first catalytic layer is covered with the electrolyte layer, the electrolyte layer is covered with the second catalytic layer, and the second catalytic layer is covered with the ring electrode.

### CROSS-REFERENCES TO RELATED APPLICATIONS

This non-provisional application claims priority under 35 U.S.C. § 119(a) on Patent Application No(s). 95130206 filed in Taiwan, R.O.C. on 2006 Aug. 17, the entire contents of which are hereby incorporated by reference.

### FIELD OF INVENTION

The present invention relates to a fuel cell, more particularly, to a column type fuel cell, series device thereof and stack thereof.

### BACKGROUND

A fuel cell is a power device for transforming liquid fuels into the power through an electrochemistry process. Compared with traditional power sources, the fuel cell has the advantages, such as low pollution, low noise, high energy density, higher energy transforming efficiency. The fuel cell has better development perspective on a clean power source. The fuel cell is widely applied in domestic power systems, electronic products, transportation, military equipment, space industry, etc.

The fuel cell is generally formed of several basic units. Each basic unit provides very little voltages, so in use, many basic units are connected in series for providing sufficient operating voltages.

Most of conventional fuel cells are flat structures. Two surfaces of the flat structure are a cathode and an anode of the fuel cell, respectively. In the structure, two surfaces of an electrolyte membrane are connected to the electrodes, i.e. a fuel electrode and an oxidant electrode, respectively. Hydrogen is provided for the fuel electrode, and oxygen or air is provided for the oxidant electrode, thereby powering by the electrochemistry reaction.

As an example of a solid polymer fuel cell, it includes a proton exchange membrane which is a solid polymer electrolyte membrane, a catalytic layer and current collectors. The catalytic layer is formed with a catalyzer layer disposed on the surface of the proton exchange membrane and a gas diffusion layer. The catalyzer layer is formed with carbon particles of catalysts and a mixture of the solid polymer electrolyte, and the gas diffusion layer is formed with a porous material for providing and diffusing the fuels and oxidation gases. The current collector is formed with a conductive sheet made of carbon or metal.

The voltage of the fuel cell unit is 1.23 V at most. Many portable electronic devices operate with input voltages of about 1.5V to 4V. Therefore, the fuel cell units must be connected in series to improve the voltages of the battery.

In general, the common batteries are the column type batteries each whose ends are the cathode and the anode, respectively. When the electronic device is driven by the fuel cells replacing the common batteries, it needs either to change a battery coupling of the electronic device or to series-connect many fuel cell units to form the battery coupling corresponding to the electronic device.

Therefore, there is still improvement in the structure design of the fuel cell.

### SUMMARY

The present invention overcomes the problems of the prior art by providing a column type fuel cell, series device thereof and stack thereof to solve various problems and limitations existing in the prior art.

It is, therefore, the primary object of the present invention is to provide the column type fuel cell comprises a column electrode, a first catalytic layer, one or more channels, an electrolyte layer, a second catalytic layer and a ring electrode.

A surrounding surface of the column electrode has several protruding blocks. The first catalytic layer is disposed on the surrounding surface of the column electrode, and it is connected to the protruding blocks, to form a pillar. So the channels are formed between the first catalytic layer and the column electrode. The channels pass through two ends of the pillar. The first catalytic layer is covered with the electrolyte layer, the electrolyte layer is covered with the second catalytic layer, and the second catalytic layer is covered with the ring electrode.

The column electrode can be a solid pillar or a hollow pillar.

A top surface of the protruding block can include at least a vein structure, thereby increasing contact areas between the column electrode and the first catalytic layer.

A series device, for connecting the column type fuel cells to form a column type fuel cell stack, comprises many through holes, to achieve the series connection of the conductivity and the fuels.

The present invention will be apparent in its objects, features and advantages after reading the detailed description of the preferred embodiment thereof in reference to the accompanying drawings.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a three-dimensional view of a column type fuel cell according to first embodiment of the invention;

FIG. 2 is a three-dimensional view of the column type fuel cell according to second embodiment of the invention;

FIG. 3 is a three-dimensional view of the column type fuel cell according to third embodiment of the invention;

FIG. 4 is a three-dimensional view illustrating first embodiment of a column electrode of the column type fuel cell according to the invention;

FIG. 5 is a three-dimensional view illustrating second embodiment of the column electrode of the column type fuel cell according to the invention;

FIG. 6 is a three-dimensional view illustrating third embodiment of the column electrode of the column type fuel cell according to the invention;

FIG. 7 is a three-dimensional view illustrating fourth embodiment of the column electrode of the column type fuel cell according to the invention;

FIG. 8 is a three-dimensional view illustrating fifth embodiment of the column electrode of the column type fuel cell according to the invention;

FIG. 9A is a partial sectional view illustrating first embodiment of a top surface of a protruding block in the column type fuel cell according to the invention;

FIG. 9B is a partial sectional view illustrating second embodiment of the top surface of the protruding block in the column type fuel cell according to the invention;

FIG. 9C is a partial sectional view illustrating third embodiment of the top surface of the protruding block in the column type fuel cell according to the invention;

FIG. 10 is a three-dimensional view illustrating sixth embodiment of the column electrode of the column type fuel cell according to the invention;

FIG. 11 is a three-dimensional view illustrating seventh embodiment of the column electrode of the column type fuel cell according to the invention;

FIG. 12 is a three-dimensional view of the column type fuel cell according to fourth embodiment of the invention;

FIG. 13A is a sectional view of the column type fuel cell according to fifth embodiment of the invention;

FIG. 13B is a sectional view of the column type fuel cell according to sixth embodiment of the invention;

FIG. 13C is a sectional view of the column type fuel cell according to seventh embodiment of the invention;

FIG. 13D is a sectional view of the column type fuel cell according to eighth embodiment of the invention;

FIG. 14A is a three-dimensional view illustrating an embodiment of a series device shown in FIG. 13A;

FIG. 14B is a three-dimensional view illustrating an embodiment of the series device shown in FIG. 13B;

FIG. 15A is a three-dimensional view illustrating first embodiment of the series device shown in FIG. 13C;

FIG. 15B is a three-dimensional view illustrating second embodiment of the series device shown in FIG. 13C;

FIG. 16A is a three-dimensional view illustrating first embodiment of the series device shown in FIG. 13D;

FIG. 16B is a three-dimensional view illustrating second embodiment of the series device shown in FIG. 13D;

FIG. 17A is a sectional view of the column type fuel cell according to ninth embodiment of the invention;

FIG. 17B is a sectional view of the column type fuel cell according to tenth embodiment of the invention;

FIG. 18A is a three-dimensional view illustrating an embodiment of the series device shown in FIG. 17A; and

FIG. 18B is a three-dimensional view illustrating an embodiment of the series device shown in FIG. 17B.

### DETAILED DESCRIPTION

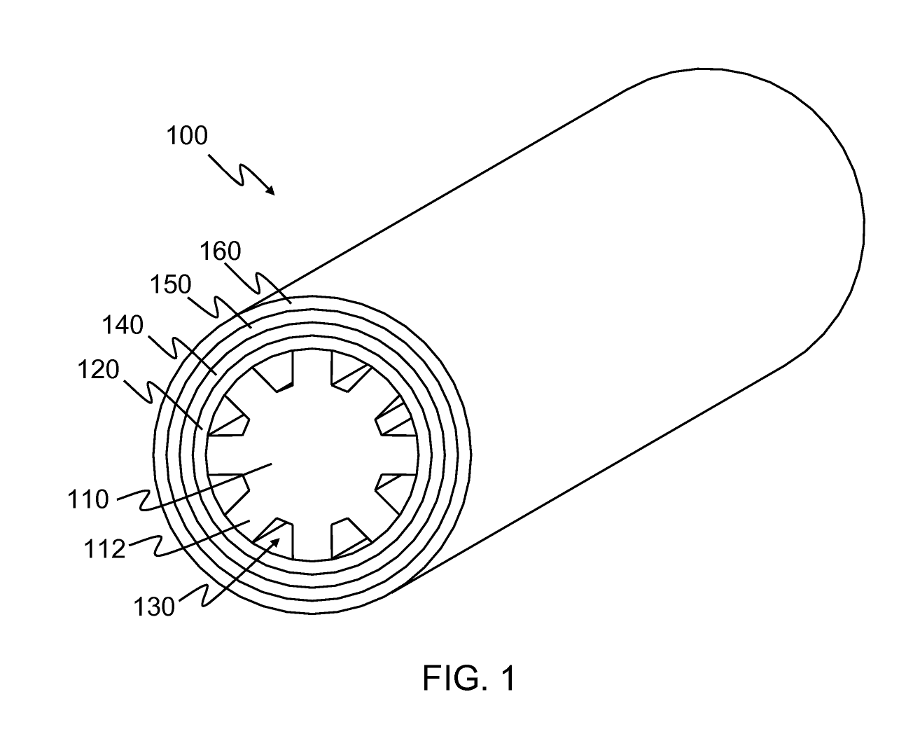

Please refer to FIGS. 1, 2, and 3. FIGS. 1 to 3 show a column type fuel cell according to the present invention, comprising a column electrode 110, a first catalytic layer 120, one or more channels 130, an electrolyte layer 140, a second catalytic layer 150 and a ring electrode 160.

The column electrode 110 presents a column type, which has two ends and a surrounding surface. There are several protruding blocks 112 on the surrounding surface of the column electrode 110. The first catalytic layer 120 is disposed on the surrounding surface of the column electrode 110, to form a pillar. The first catalytic layer 120 is connected to the protruding blocks 112 to form the channels 130 between the first catalytic layer 120 and the column electrode 110. The channels 130 pass through two ends of the pillar. The first catalytic layer 120 is covered with the electrolyte layer 140, the electrolyte layer 140 is covered with the second catalytic layer 150, and the second catalytic layer 150 is covered with the ring electrode 160.

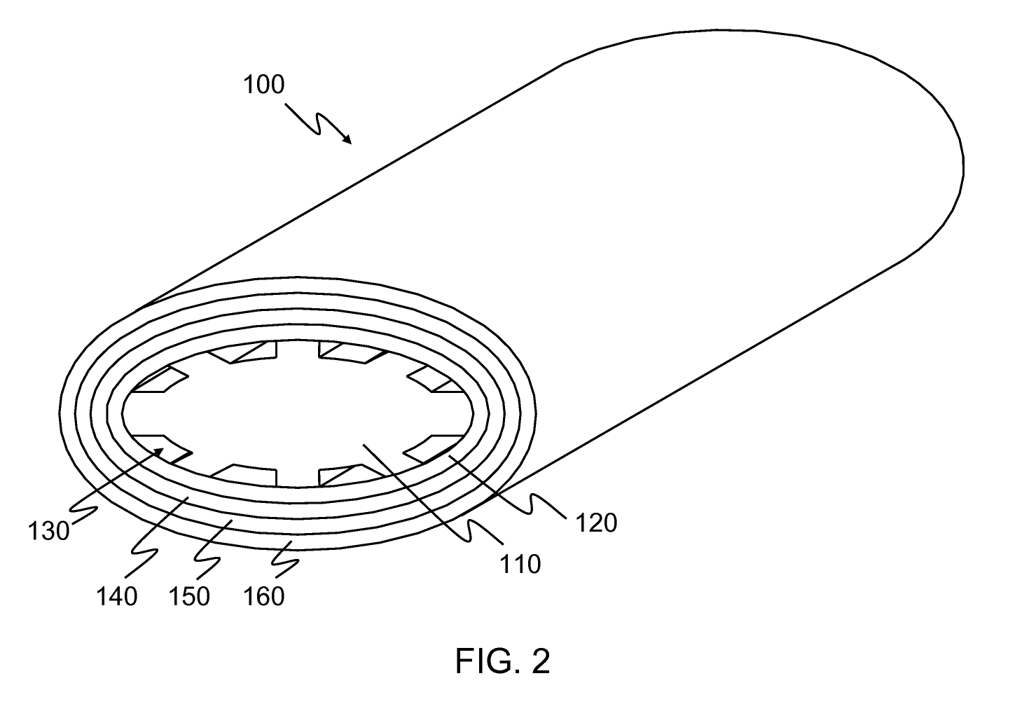

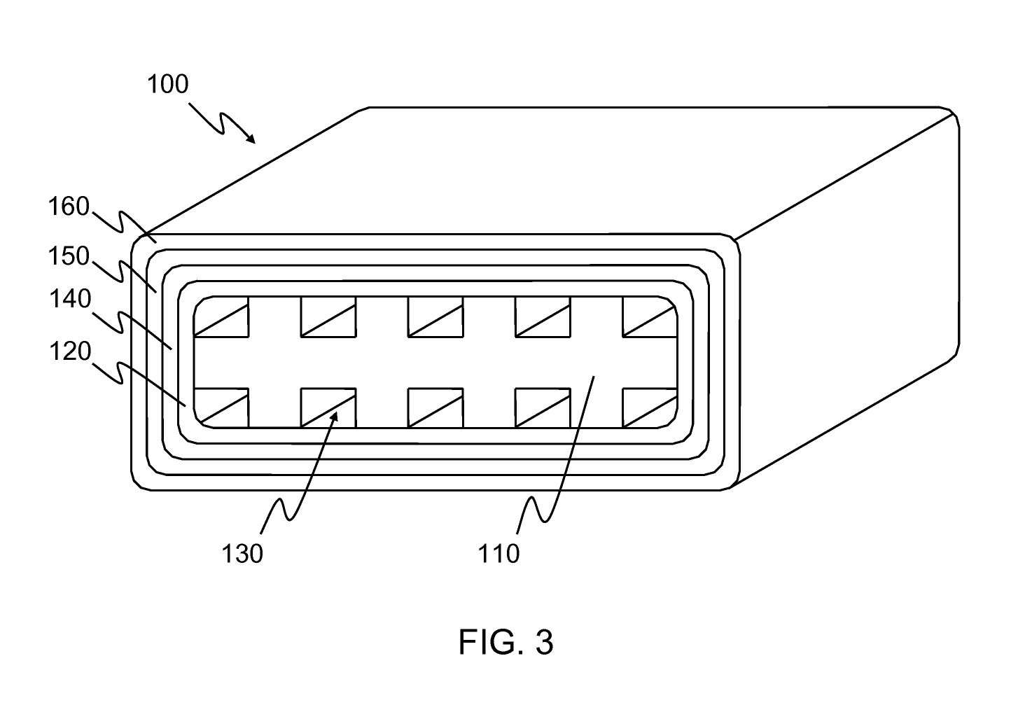

The pillar can be a cylinder (as shown in FIG. 1), an elliptic cylinder (as shown in FIG. 2), a square pillar (as shown in FIG. 3), a triangle pillar (not shown), or a pillar of random shape (not shown).

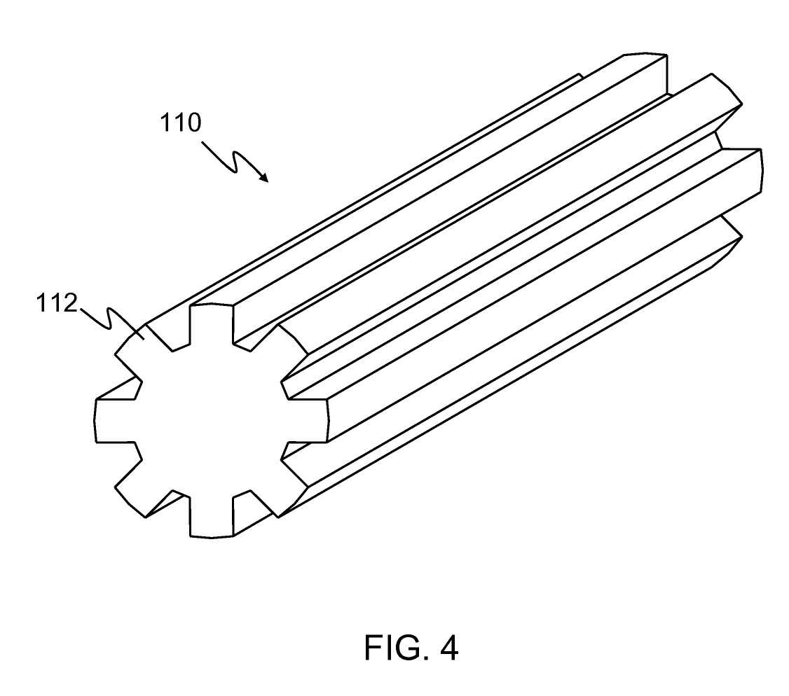

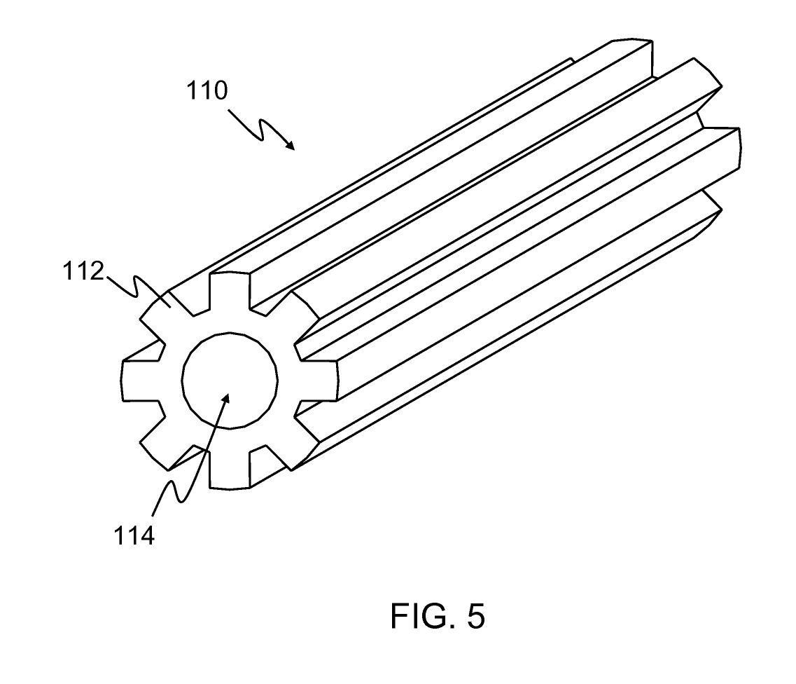

The column electrode can be a solid pillar (as shown in FIG. 4) or a hollow pillar, i.e. its core is a channel 114 (as shown in FIG. 5).

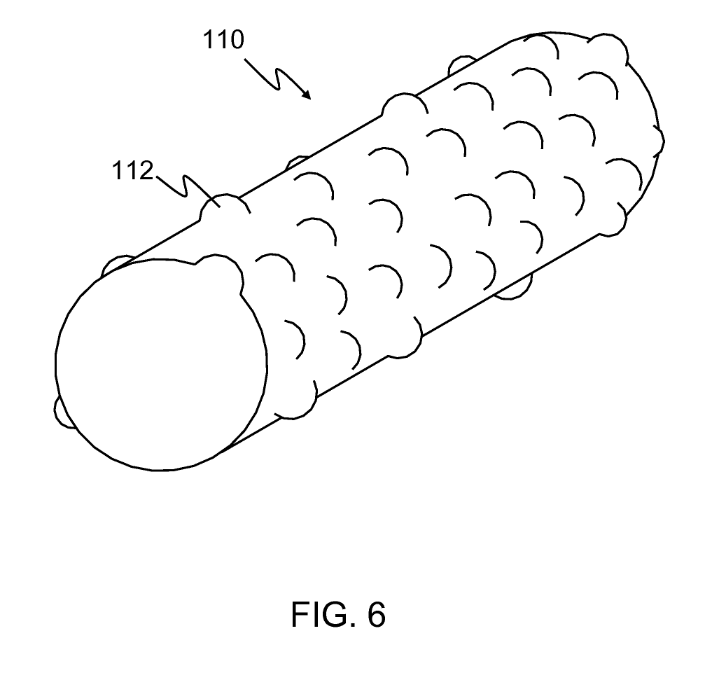

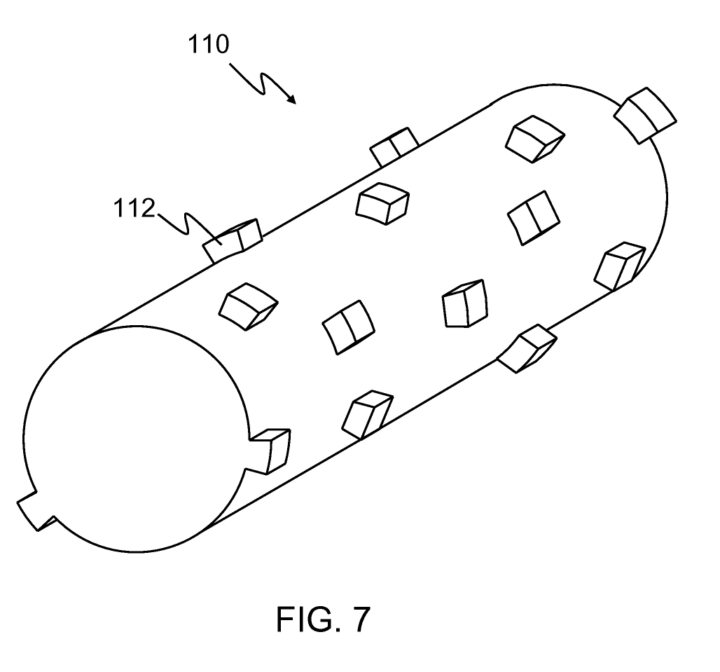

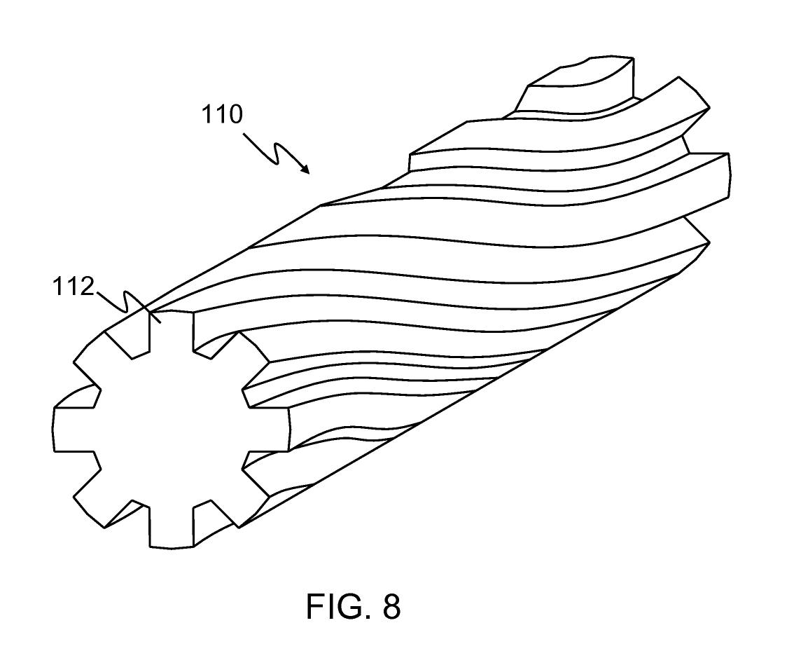

The protruding blocks 112 in the column electrode 110 can include at least a strip block, directly or spirally extending from one end of the pillar to the other (as shown in FIGS. 4 and 8). Moreover, the protruding block 112 also can be prominence with random shape, as shown in FIGS. 6 and 7.

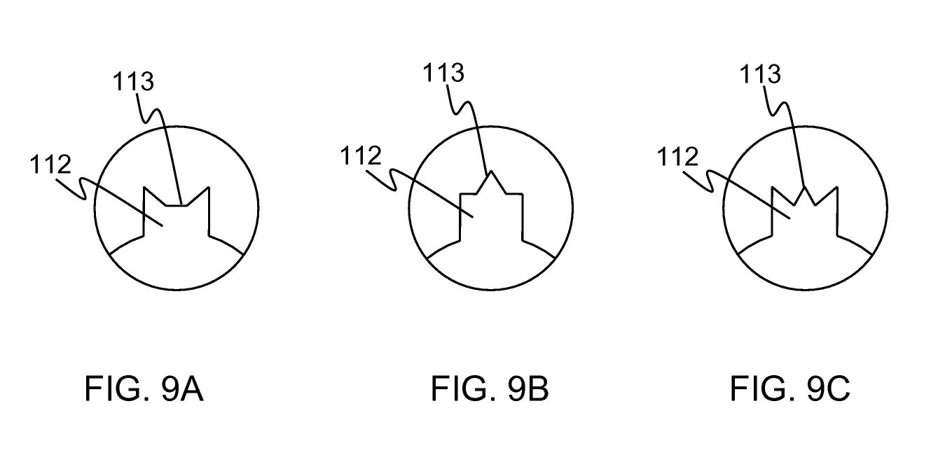

Referring to FIGS. 9A, 9B, and 9C, a top surface of the protruding block 112 includes at least a vein structure 113, thereby increasing contact areas between the column electrode and the first catalytic layer. The vein structure can be a helical vein structure, an oblique vein structure, a straight trip structure, a saw vein structure, a ladder-like structure, a random shape structure, or a combination thereof.

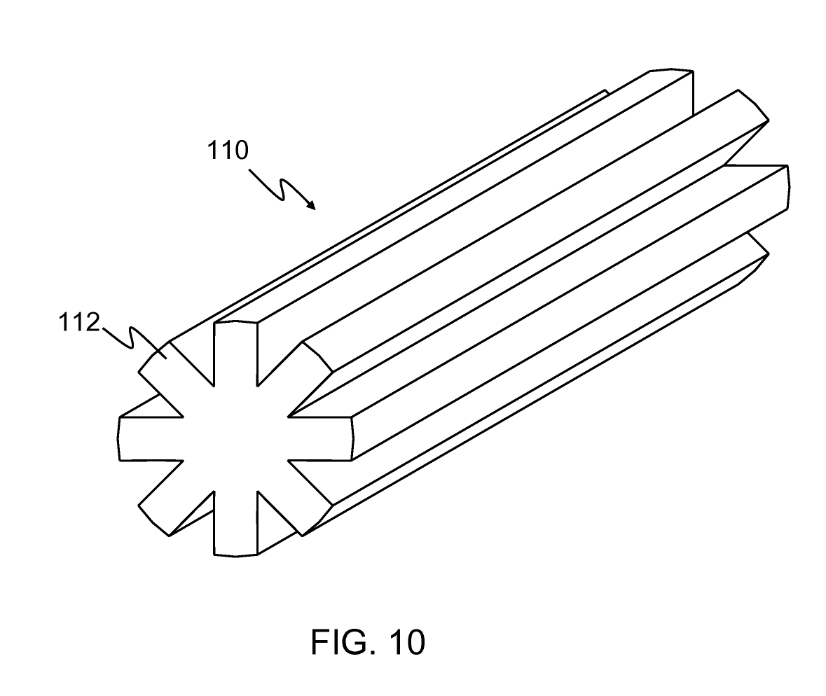

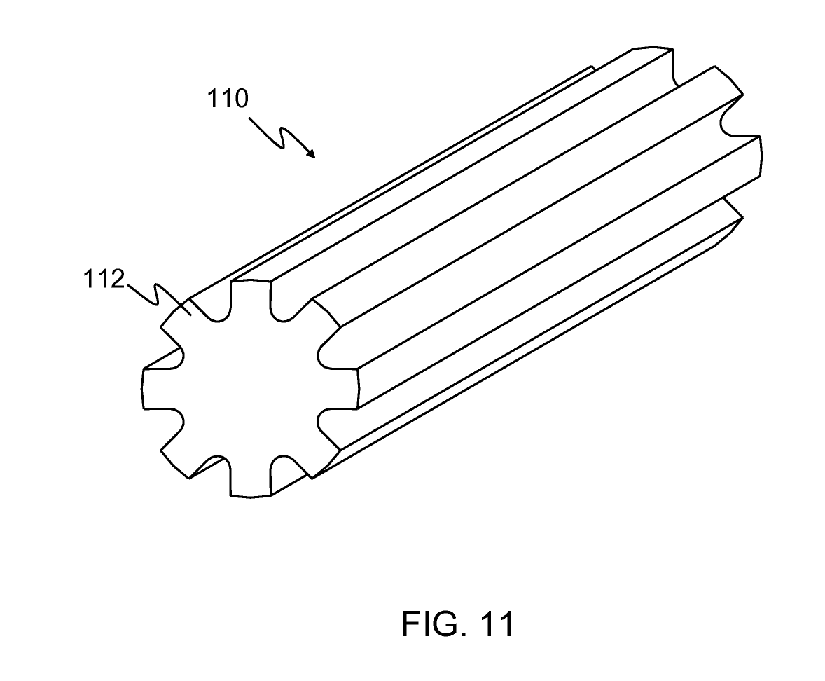

Further, the bottom of the channel 130 can be substantial flat (as shown in FIG. 4), or present V-type (as shown in FIG. 10), or U-type (as shown in FIG. 11), etc.

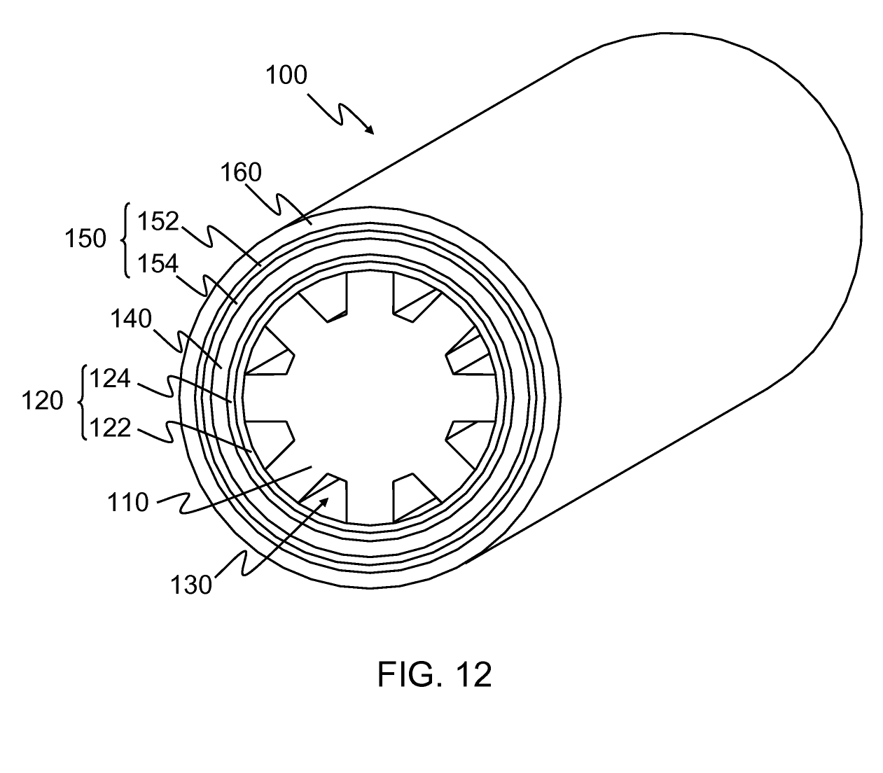

Referring to FIG. 12, the first catalytic layer 120 includes a diffusion layer 122 and a catalyzer layer 124, and the second catalytic layer 150 includes a diffusion layer 152 and a catalyzer layer 154.

The diffusion layer 122 is disposed on the surrounding surface of the column electrode 110, and connected to the protruding blocks 112, to form channels 130 with the column electrode 110. The catalyzer layer 124 is disposed between the diffusion layer 122 and the electrolyte layer 140.

The electrolyte layer 140 is covered with the catalyzer layer 154, and the diffusion layer 152 is disposed between the catalyzer layer 154 and the ring electrode 160.

In an embodiment, the column electrode and the ring electrode are oppositely polar electrodes, e.g. the column electrode is a cathode and the ring electrode is an anode.

In battery design, it can determine the output power of single battery by controlling the length of the column type fuel cell. In other words, it can achieve promoting the output power of single battery by increasing the length of the column type fuel cell. Furthermore, it can achieve promoting the voltage of single battery by the series connection of the conductivity and the fuels of the column type fuel cells using a series device. Therefore, it can provide more flexibility in manufacture and assembly.

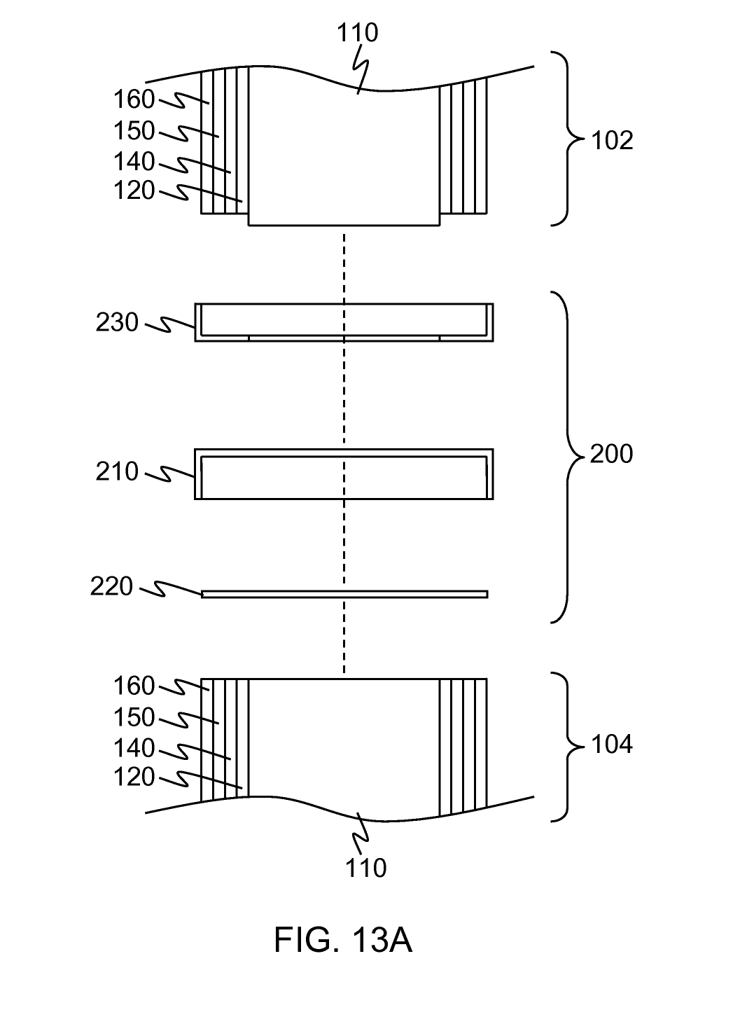

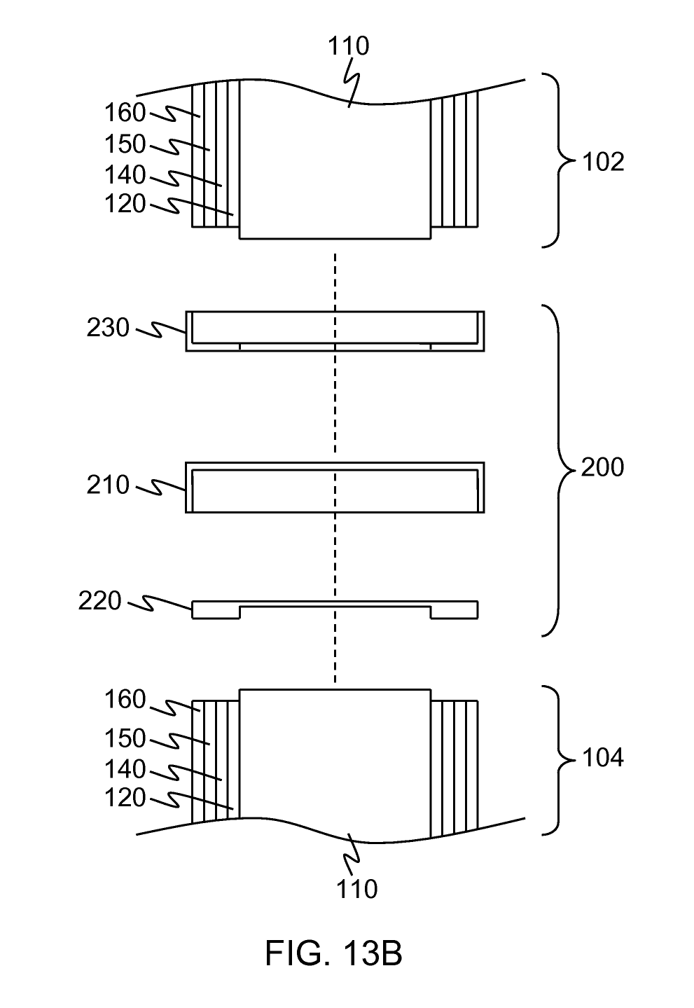

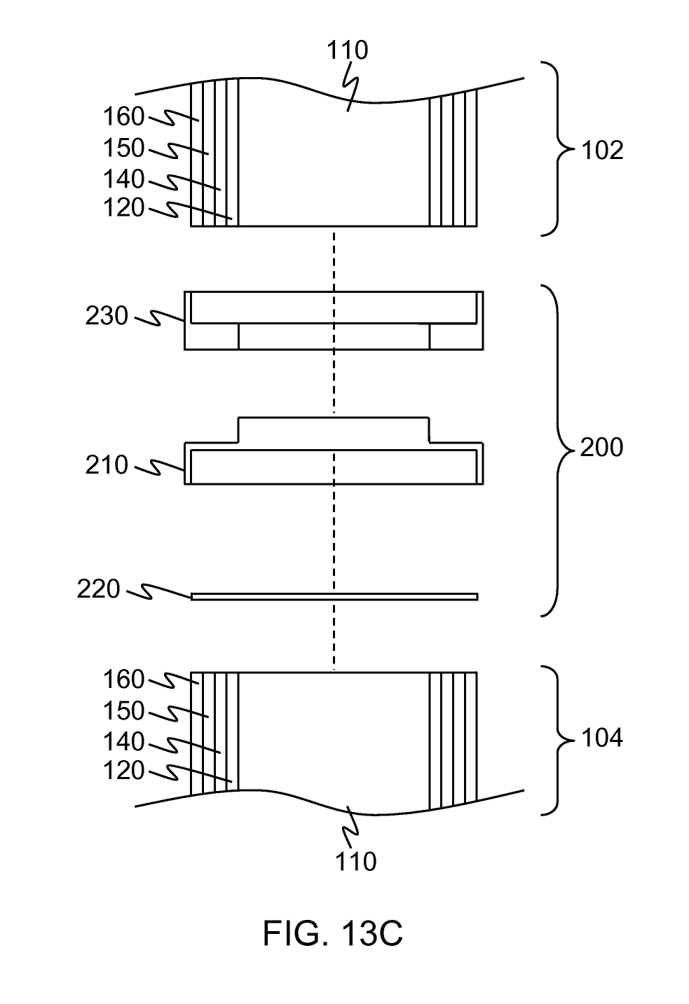

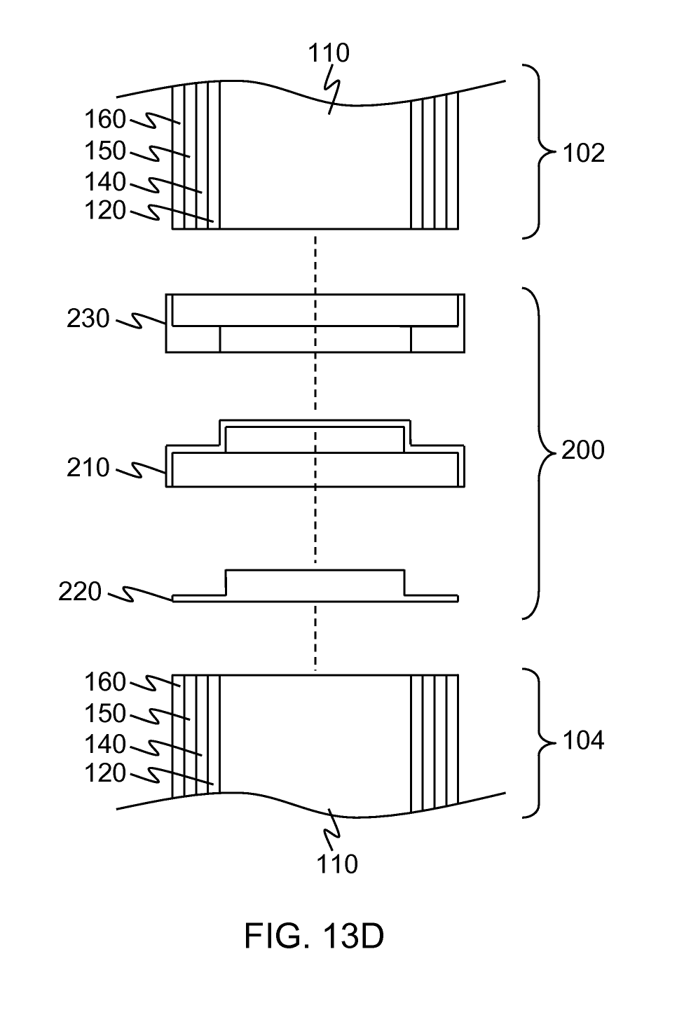

Please refer to FIGS. 13A, 13B, 13C, and 13D. FIGS. 13A to 13D show the series device according to the present invention, for connecting the column type fuel cells to form a column type fuel cell stack, to achieve the series connection of the conductivity and the fuels. The series device 200 includes a conductive cap 210, an insulating sheet 220 and an insulating ring 230.

The insulating sheet 220 and the insulating ring 230 are disposed on inside and outside surfaces of the bottom of the conductive cap 210, respectively.

The edge of the conductive cap 210 is connected to a column electrode 110 of a first fuel cell 102, which is a first pillar, and the outside surfaces of the bottom of the conductive cap 210 is connected to a ring electrode 160 of a second fuel cell 104, which is a second pillar.

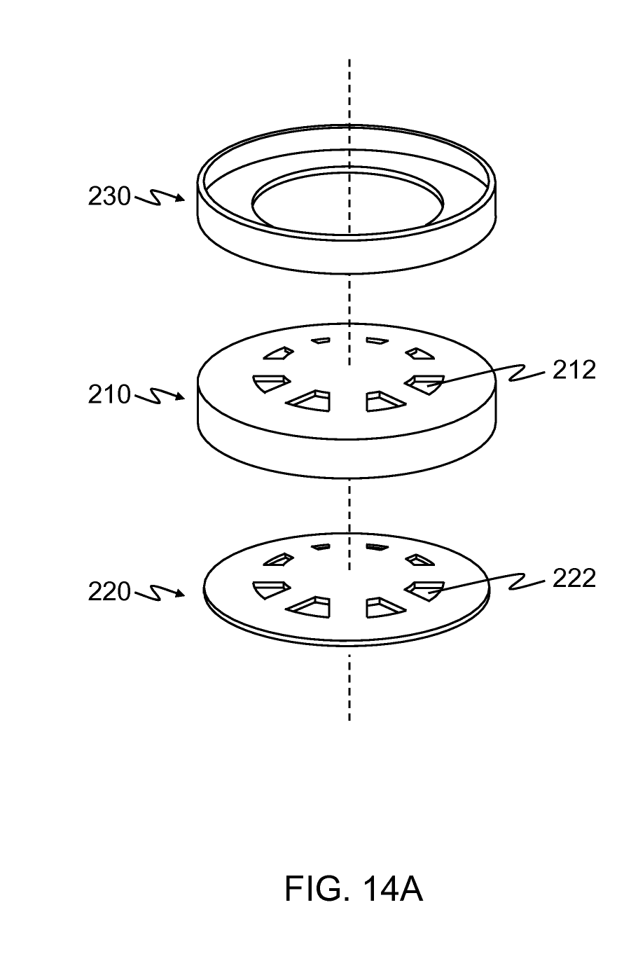

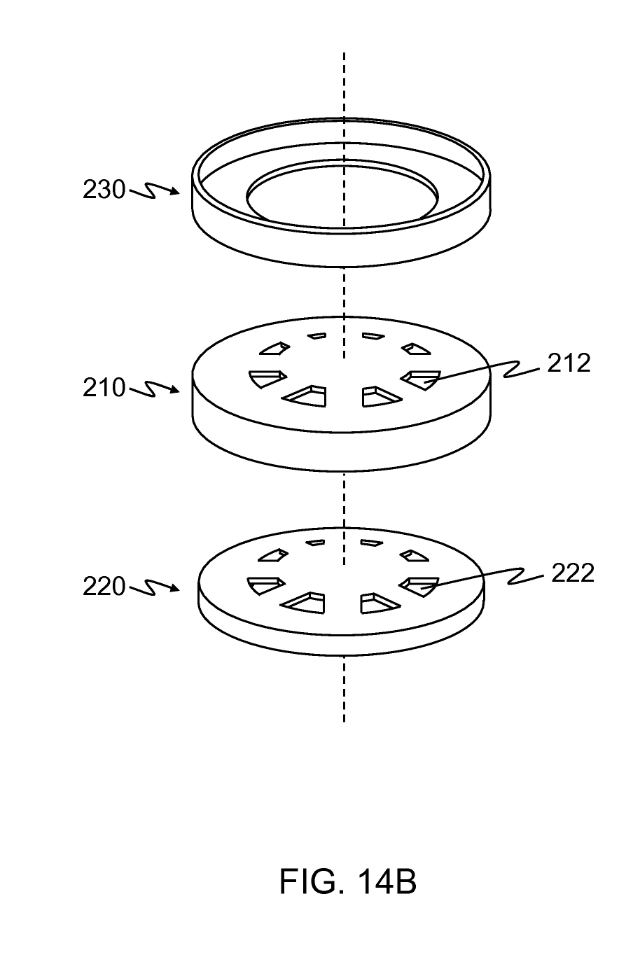

Referring to FIGS. 14A and 14B, the bottom of the conductive cap 210 has many first through holes 212, and the insulating sheet 220 has many second through holes 222. The second through holes 222 communicate with the first through holes 212, to communicate with the channels of the column type fuel cells, i.e. the first and second fuel cells 102, 104 when the column type fuel cells are connected in series.

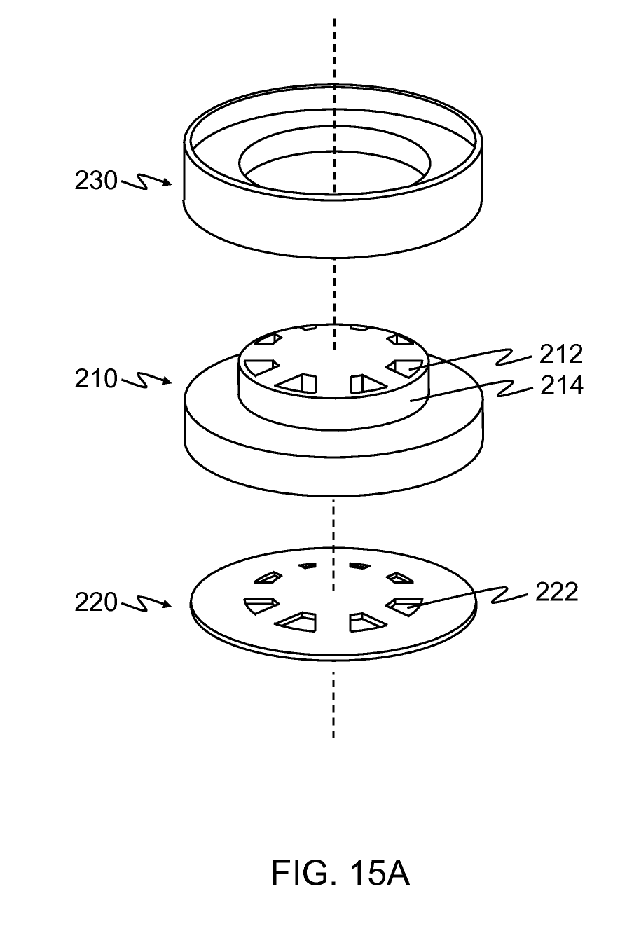

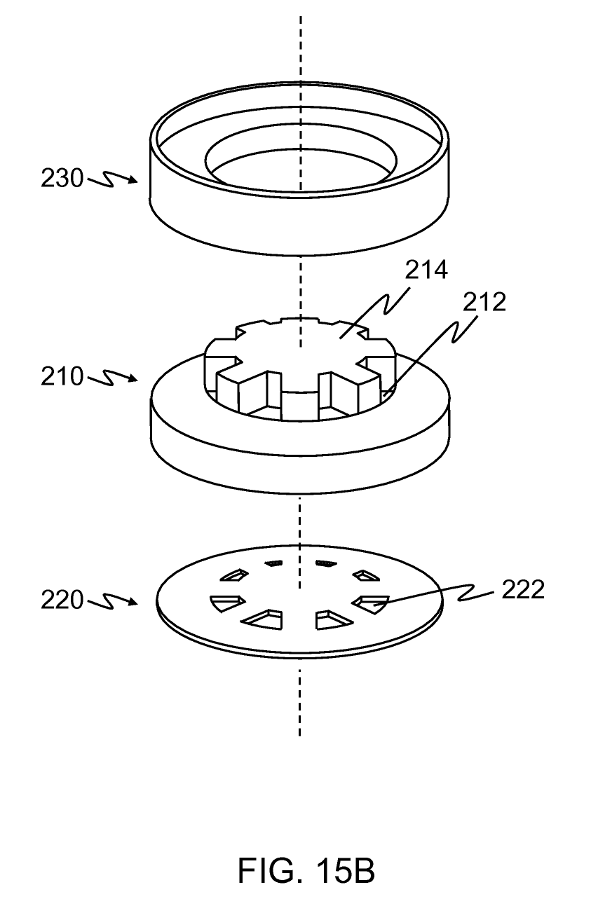

Referring to FIGS. 15A and 15B, the bottom of the conductive cap 210 has a prominent section 214 protruding. The insulating ring 230 can be designed to be connected to the prominent section 214.

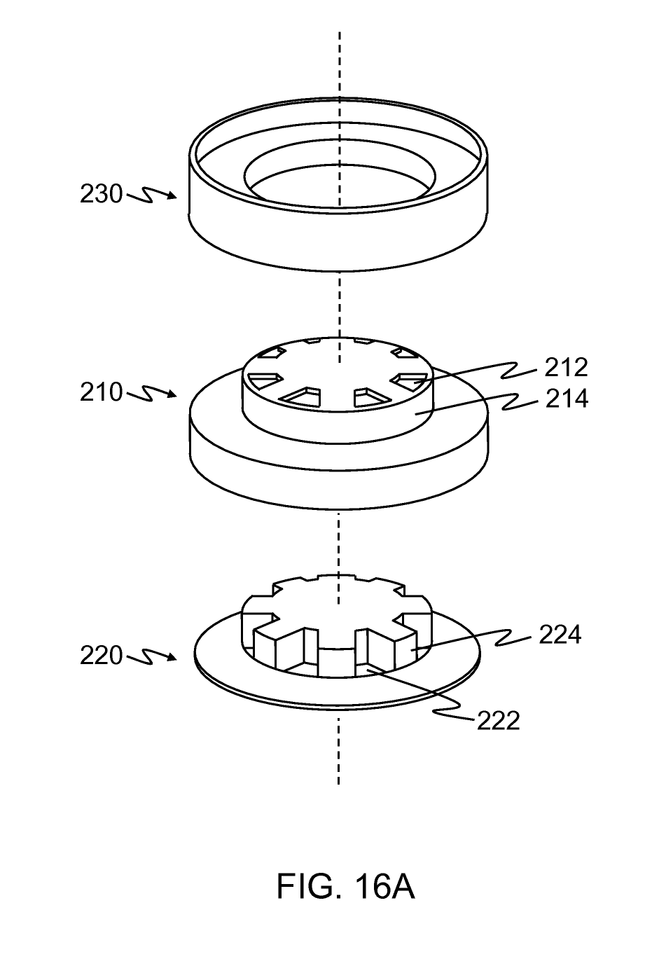

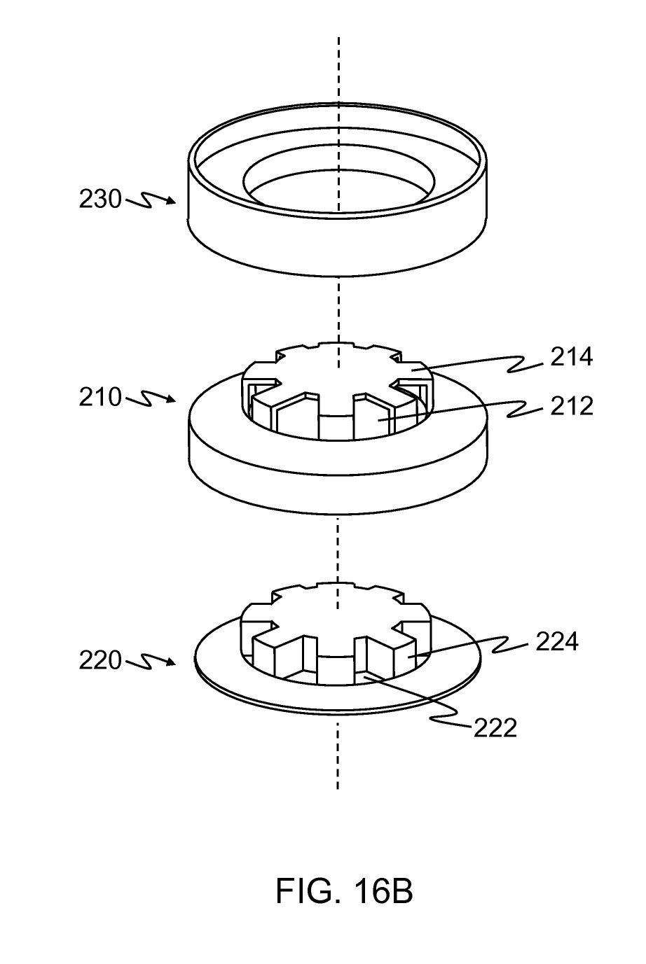

Referring to FIGS. 16A and 16B, the insulating sheet 220 has a prominent section 224 for being inserted into the prominent section 214.

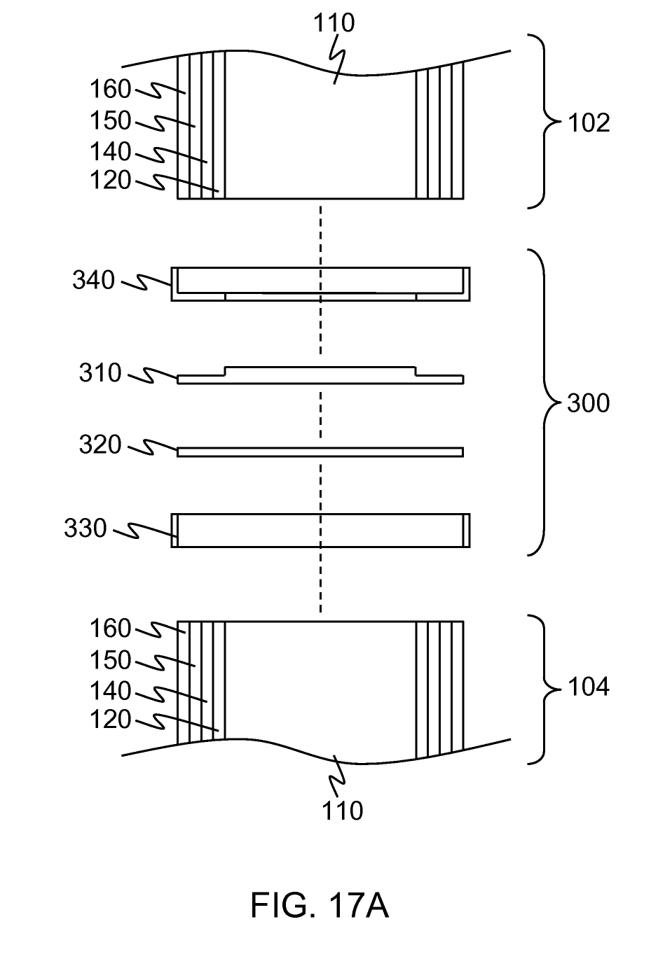

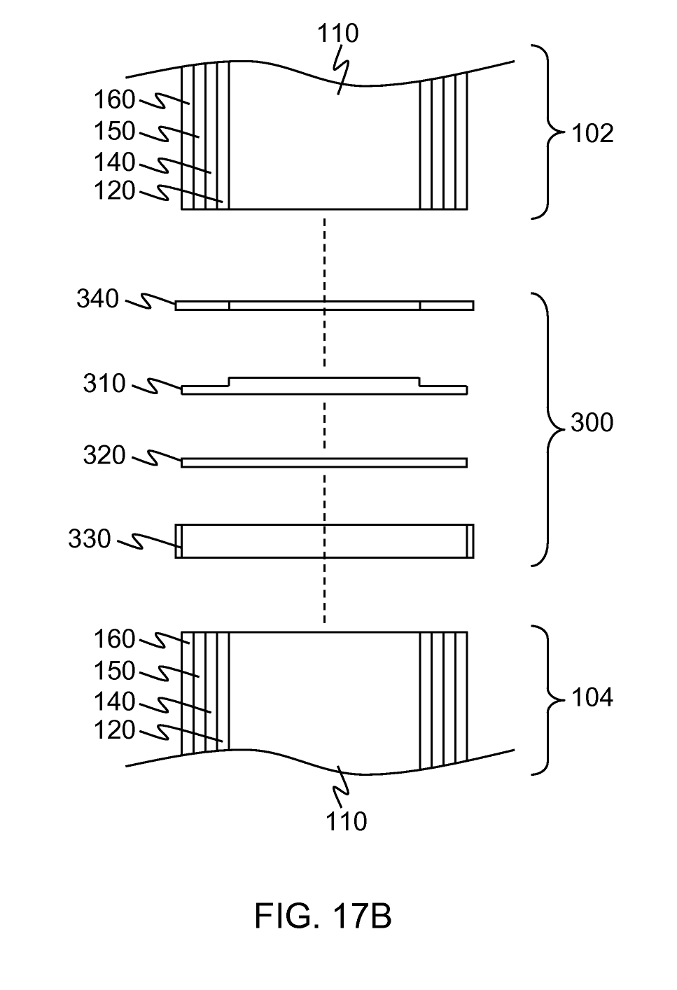

Please refer to FIGS. 17A and 17B. FIGS. 17A and 17B show the series device according to the present invention, for connecting the column type fuel cells to form a column type fuel cell stack, to achieve the series connection of the conductivity and the fuels. The series device 300 includes a conductive sheet 310, an insulating sheet 320, a conductive ring 330, and an insulating ring 340.

A first fuel cell 102, the insulating ring 340, the conductive sheet 310, the insulating sheet 320, the conductive ring 330 and a second fuel cell 104 are connected in order, to connect the conductivities and the fuels of the first fuel cell 102 and the second fuel cell 104.

A center of the surface of the conductive sheet 310 is electrically connected to the column electrode 110 of the first fuel cell 102, the edge of the conductive sheet 310 is electrically connected to the conductive ring 330, and the conductive ring 330 is electrically connected to the ring electrode 160 of the second fuel cell 104.

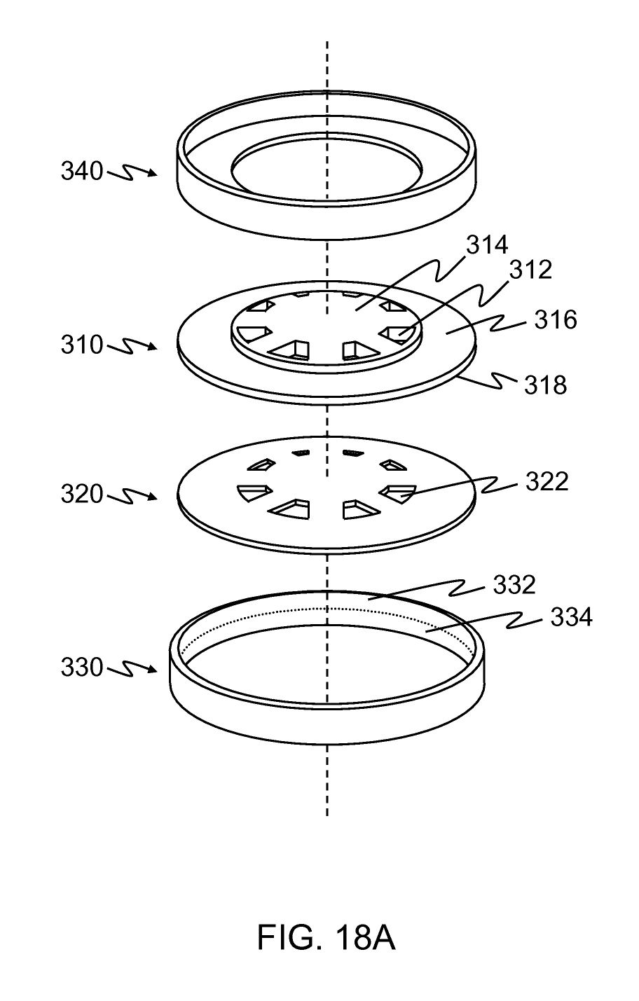

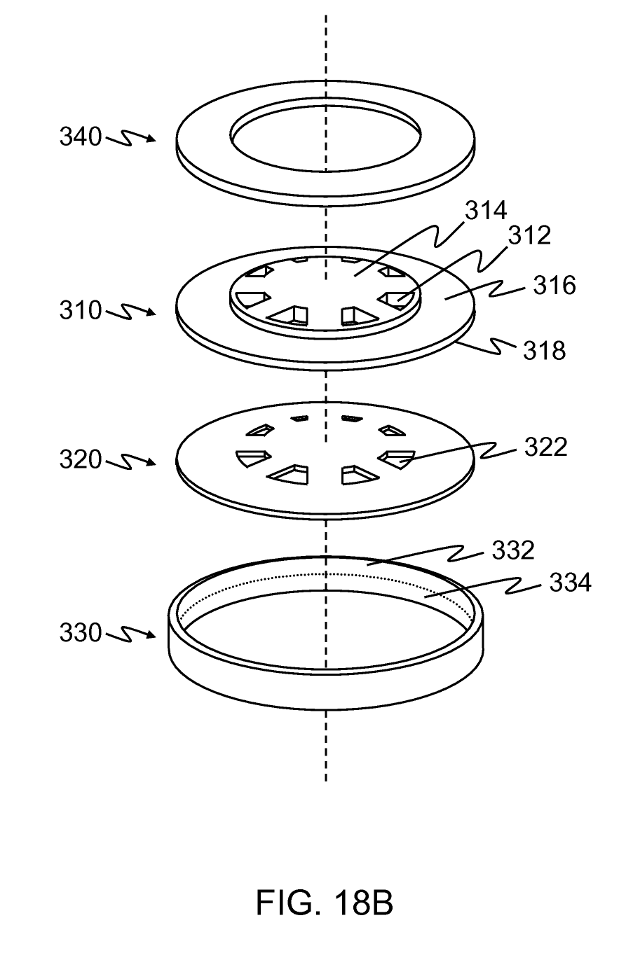

Referring to FIGS. 18A and 18B, the conductive sheet 310 has a first surface 316, a second surface 318, a prominent section 314 and several first through holes 312.

The prominent section 314 is disposed on the first surface 316. The first through holes 312 pass through the conductive sheet 310 and are disposed along the edge of the prominent section 314.

The insulating sheet 320 is disposed on the second surface 318, and has several second through holes 322 corresponding to the first through holes 312.

The conductive ring 330 includes a fixing section 332 and a series-connection section 334.

The fixing section 332 is connected to the conductive sheet 310 and the edge of the insulating sheet 320, and the series-connection section 334 is connected to the fixing section 332 and used for being connected to the ring electrode 160 of the second fuel cell 104.

The insulating ring 340 is disposed on the first surface 316. The first surface 316 is covered with the insulating ring 340, which exposes the prominent section 314 and the first through holes 312.

The first through holes 312 can be disposed outside the edge of the prominent section 314 or in the prominent section 314.

The preferred embodiments disclosed are only for illustrating the present invention, and not for giving any limitation to the scope of the present invention. It will be apparent to those skilled in this art that various modifications or changes can be made to the present invention without departing from the spirit and scope of this invention. Accordingly, all such modifications and changes also fall within the scope of protection of the appended claims.

What is claimed is:

1. A column type fuel cell, comprising:
a column electrode, including a surrounding surface with a plurality of protruding blocks;
a first catalytic layer, disposed on the surrounding surface of the column electrode and connected to the protruding blocks, to form a pillar;
at least a channel, disposed between the column type electrode and the first catalytic layer, for passing through two ends of the pillar;
an electrolyte layer, disposed on the first catalytic layer;
a second catalytic layer, disposed on the electrolyte layer; and
a ring electrode, disposed on the second catalytic layer.

2. The column type fuel cell of claim 1, wherein the column electrode is a solid pillar.

3. The column type fuel cell of claim 1, wherein the column electrode is a hollow pillar.

4. The column type fuel cell of claim 1, wherein the protruding blocks includes at least a strip block, extending from one end of the pillar to the other.

5. The column type fuel cell of claim 1, wherein a top surface of the protruding block includes at least a vein structure.

6. The column type fuel cell of claim 5, wherein the vein structure is selected from the group consisting of helical vein structure, oblique vein structure, straight trip structure, saw vein structure, and ladder-like structure.

7. The column type fuel cell of claim 1, wherein the first catalytic layer comprises:
a diffusion layer, disposed on the surrounding surface of the column electrode, to form the channel with the column electrode; and
a catalyzer layer, disposed between the diffusion layer and the electrolyte layer.

8. The column type fuel cell of claim 1, wherein the second catalytic layer comprises:
a catalyzer layer, disposed on the electrolyte layer; and
a diffusion layer, disposed on between the catalyzer layer and the ring electrode.

9. A series device of fuel cells, comprising:
a conductive cap, whose bottom has a plurality of first through holes;
an insulating sheet, disposed on an inside surface of the bottom of the conductive cap, and having a plurality of second through holes connected to the first through holes; and
an insulating ring, disposed on an outside surface of the bottom of the conductive cap.

10. The series device of claim 9, wherein the bottom of the conductive cap comprises a prominent section protruding.

11. The series device of claim 10, wherein the insulating ring is connected to the prominent section.

12. A series device of fuel cells, comprising:
a conductive sheet, which comprises:
a first surface;
a second surface;
a prominent section, disposed on the first surface; and
a plurality of first through holes, which pass through the conductive sheet and are disposed along the edge of the prominent section;
an insulating sheet, which is disposed on the second surface, and has a plurality of second through holes corresponding to the first through holes;
a conductive ring, which comprises:
a fixing section, connected to the conductive sheet and the edge of the insulating sheet; and
a series-connection section, connected to the fixing section; and
an insulating ring, which the first surface is covered with, and the prominent section and the first through holes are exposed by.

13. The series device of claim 12, wherein the first through holes are disposed on the prominent section.

14. A column type fuel cell stack, comprising:
a first fuel cell, which is a first pillar, and comprises:
a column electrode, which is the core of the first pillar, and extends from one end of the first pillar to the other, and includes a surrounding surface with a plurality of protruding blocks, to form at least a channel passing through the ends of the first pillar; and
a ring electrode, disposed on the surrounding surface of the first pillar;
a second fuel cell, which is a second pillar, and comprises:
a column electrode, which is the core of the second pillar, and extends from a end to the other of the second pillar, and includes a surrounding surface with a plurality of protruding blocks, to form at least a channel passing through the ends of the second pillar; and
a ring electrode, disposed on the surrounding surface of the second pillar; and
a series device, which comprises:
a conductive cap, whose edge is connected to the column electrode of the first fuel cell, and an outside surface of whose bottom is connected to the column electrode of the second fuel cell;
an insulating sheet, disposed between the conductive cap and the first fuel cell;
a plurality of first through holes, disposed in the bottom of the conductive cap, and connected to the channels passing through the second fuel cell;
a plurality of second through holes, disposed in the insulating sheet, for connecting the first through holes and the channels passing through the first fuel cell; and
an insulating ring, for connecting the conductive cap and the second fuel cell.

15. The column type fuel cell stack of claim 14, wherein the column electrode is a solid pillar.

16. The column type fuel cell stack of claim 14, wherein the column electrode is a hollow pillar.

17. The column type fuel cell stack of claim 14, wherein the protruding blocks includes at least a strip block.

18. The column type fuel cell stack of claim 14, wherein a top surface of the protruding blocks includes at least a vein structure.

19. The column type fuel cell stack of claim 18, wherein the vein structure is selected from the group consisting of helical vein structure, oblique vein structure, straight trip structure, saw vein structure, and ladder-like structure.

20. The column type fuel cell stack of claim 14, wherein the insulating ring separates the conductive cap and the ring electrode of the second fuel cell.

21. The column type fuel cell stack of claim 14, wherein the bottom of the conductive cap comprises a prominent section protruding.

22. The column type fuel cell stack of claim 14, wherein the insulating ring is connected to the prominent section.

23. A column type fuel cell stack, comprising:
a first fuel cell, which is a first pillar, and comprises:
a column electrode, which is the core of the first pillar, and extends from one end of the first pillar to the other, and includes a surrounding surface with a plurality of protruding blocks, to form at least a channel passing through the ends of the first pillar; and
a ring electrode, disposed on the surrounding surface of the first pillar;
a second fuel cell, which is a second pillar, and comprises:
a column electrode, which is the core of the second pillar, and extends from one end of the second pillar to the other, and includes a surrounding surface with a plurality of protruding blocks, to form at least a channel passing through the ends of the second pillar; and
a ring electrode, disposed on the surrounding surface of the second pillar; and
a series device, which comprises:
a conductive sheet, which comprises:
a prominent section, connected to the column electrode of the first fuel cell;
a plurality of first through holes, connected to the channels passing through the first fuel cell;
an insulating ring, disposed between the conductive sheet and the first fuel cell;
an insulating sheet, which is disposed between the conductive sheet and the second fuel cell, and comprises:
a plurality of second through holes, for connecting the first through holes and the channels passing through the second fuel cell; and
a conductive ring, connected to the conductive sheet, the edge of the insulating sheet, and the ring electrode of the second fuel cell.

24. The column type fuel cell stack of claim 23, wherein the column electrode is a solid pillar.

25. The column type fuel cell stack of claim 23, wherein the column electrode is a hollow pillar.

26. The column type fuel cell stack of claim 23, wherein the protruding blocks includes at least a strip block.

27. The column type fuel cell stack of claim 23, wherein a top surface of the protruding blocks includes at least a vein structure.

28. The column type fuel cell stack of claim 27, wherein the vein structure is selected from the group consisting of helical vein structure, oblique vein structure, straight trip structure, saw vein structure, and ladder-like structure.

29. The column type fuel cell stack of claim 23, wherein the first through holes are disposed in the prominent section.
